(19) United States
(12) Patent Application Publication
(10) Pub. No.: US 2026/0214292 A1
(43) Pub. Date: Jul. 23, 2026

(54) DISPLAY DEVICE AND OPERATING METHOD THEREOF

(71) Applicant: LG ELECTRONICS INC., Seoul (KR)

(72) Inventor: Miyeon KWON, Seoul (KR)

(73) Assignee: LG ELECTRONICS INC., Seoul (KR)

(21) Appl. No.: 19/141,134

(22) PCT Filed: Dec. 20, 2022
(86) PCT No.: PCT/KR2022/020776

§ 371 Date: Jun. 19, 2025

(51) Int. Cl. H04N 21/422; G06F 3/14; H04N 7/015; H04N 21/436; H04N 21/442

(52) U.S. Cl. CPC H04N 21/42204; G06F 3/14; H04N 7/015; H04N 21/43615; H04N 21/44227

(57) ABSTRACT

A display device and an operation method thereof are disclosed. A method for operating a display device, according to at least one embodiment of various embodiments of the present disclosure, may comprise the steps of: if a connection of a first external device is recognized, configuring the display device to control the first external device through an input means; outputting a video through a display; checking a status of the video to recognize a connection of a second external device; and configuring the display device to control the second external device through the input means.

### TECHNICAL FIELD

The present disclosure relates to a display device and its operating method.

### BACKGROUND

Recently, the functions of terminals have been diversified, for example, data and voice communication, taking pictures and videos using a camera, recording voice, playing music files using a speaker system, and outputting images or videos to a display.

Some terminals have an added electronic game play function or perform a multimedia player function.

As the functions of such terminals have diversified, they are implemented in the form of multimedia players with complex functions such as taking pictures or videos, playing music or video files, playing games, and receiving broadcasts.

For this reason, various external devices are connected to the display device. However, since the external input interface of the display device is limited, there was a problem that it was difficult to connect many external devices to the display device at the same time.

In addition, even if multiple external devices are connected to the display device, each external device has a different manufacturer or has different specifications, so there is a problem that it is difficult for the user to integrate and control the external devices with only one input means for the display device.

### DISCLOSURE OF THE INVENTION

### Technical Problem

The present disclosure provides a display device and an operating method thereof that provides a service for integrating and controlling multiple external devices directly/indirectly connected to the display device through one input means.

### Technical Solution

According to at least one embodiment of the present disclosure, a method of operating a display device may include when a connection of a first external device is recognized, setting the first external device to be controlled via an input means; outputting a video through a display; recognizing a connection of a second external device by checking a status of the video; and setting the second external device to be controlled via the input means.

According to the method of operating a display device according to at least one embodiment of the present disclosure, the second external device may be connected only to the first external device and not to the display device.

According to the method of operating a display device according to at least one embodiment of the present disclosure, the display device and the first external device, and the first external device and the second external device may be respectively connected via an HDMI.

According to the operating method of the display device according to at least one embodiment of the various embodiments of the present disclosure, checking the status of the video to recognize the connection of the second external device may comprise: when additional HDMI-CEC information as a result of the video status check is received, performing an operation for automatically recognizing the second external device based on the additional HDMI-CEC information.

According to the operating method of the display device according to at least one embodiment of the various embodiments of the present disclosure, when the automatic recognition of the second external device fails, a manual setup guide for controlling the second external device via the input means may be output.

According to the operating method of the display device according to at least one embodiment of the various embodiments of the present disclosure, when no additional HDMI-CEC information is received as a result of the video status check, a manual setup guide for controlling the second external device via the input means may be output.

According to the operating method of the display device according to at least one embodiment of the various embodiments of the present disclosure, the first external device may be a sound bar, and the second external device may include at least one of a set-top box and a game console.

According to at least one embodiment of the various embodiments of the present disclosure, the display device may include a display; and a controller configured to control the display, wherein the controller may be configured to: when a connection of a first external device is recognized, set the first external device to be controlled via an input means, control the display to output a video, check a status of the video to recognize a connection of a second external device, and set the second external device to be controlled via the input means.

According to the display device according to at least one embodiment of the various embodiments of the present disclosure, the second external device may be connected only to the first external device and not to the display device.

According to a display device according to at least one embodiment of the various embodiments of the present disclosure, the display device and the first external device, and the first external device and the second external device may be respectively connected via HDMI.

According to a display device according to at least one embodiment of the various embodiments of the present disclosure, the controller may be configured to: when additional HDMI-CEC information as a result of the video status check is received, perform an operation for automatically recognizing the second external device based on the additional HDMI-CEC information.

According to a display device according to at least one embodiment of the various embodiments of the present disclosure, the controller may be further configured to: when the automatic recognition of the second external device fails, control the output of a manual setup guide for controlling the second external device via the input means.

According to a display device according to at least one embodiment of the various embodiments of the present disclosure, the controller may be configured to: when no additional HDMI-CEC information is received as a result of the video status check, control the output of a manual setup guide for controlling the second external device via the input means.

According to a display device according to at least one embodiment of the various embodiments of the present disclosure, the first external device may be a sound bar, and the second external device includes at least one of a set-top box and a game console.

### Effects of the Invention

According to at least one embodiment of the present disclosure, there is an effect of being able to comprehensively control a plurality of external devices directly or indirectly connected to the display device through a single input means.

According to at least one embodiment of the present disclosure, there is an effect of improving user convenience by providing an automatic setting service so that a plurality of external devices can be comprehensively controlled through the single input means.

According to at least one embodiment of the present disclosure, there is an effect of improving user satisfaction with the display device by identifying external device(s) that are not controlled through the input means among external devices indirectly connected to the display device and providing a guide for manual connection setting.

### BRIEF DESCRIPTION OF DRAWINGS

FIG. 1 is a block diagram illustrating a configuration of a display device according to an embodiment of the present disclosure.

FIG. 2 is a block diagram of a remote control device according to an embodiment of the present invention.

FIG. 3 illustrates an example of an actual configuration of a remote control device according to an embodiment of the present invention.

FIG. 4 illustrates an example of utilizing a remote control device according to an embodiment of the present invention.

FIG. 5 is a diagram for explaining a horizontal mode and a vertical mode of a stand-type display device according to an embodiment of the present disclosure.

FIG. 6 is a diagram for explaining a direct/indirect connection method related to the present disclosure.

FIG. 7 is a block diagram of a display device for controlling a plurality of external input devices connected through one remote control device 200 according to an embodiment of the present disclosure.

FIGS. 8 and 9 are flowcharts for explaining an operation method of a display device according to an embodiment of the present disclosure.

FIG. 10 is a diagram for explaining displaying a list of connected external devices on a display device.

FIGS. 11 to 13 are drawings illustrating a setting method for integrated control via a remote control device in a display device according to an embodiment of the present disclosure.

FIG. 14 is a flowchart illustrating a method for operating a display device according to another embodiment of the present disclosure.

FIG. 15 is a flowchart illustrating a method for operating a display device according to another embodiment of the present disclosure.

FIG. 16 is a drawing illustrating a method for setting integrated control via a remote control device in a display device according to another embodiment of the present disclosure.

### BEST MODE

Hereinafter, embodiments related to the present invention will be described in more detail with reference to the drawings. The suffixes “module” and “part” for components used in the following description are given or used interchangeably only for the convenience of writing the specification, and do not have distinct meanings or roles in themselves.

The display device according to the embodiment of the present invention is, for example, an intelligent display device that adds a computer support function to the broadcast reception function, and while being faithful to the broadcast reception function, it can have an interface that is more convenient to use, such as a manual input device, a touch screen, or a space remote control, by adding an Internet function, etc. In addition, it can perform functions such as email, web browsing, banking, or games by connecting to the Internet and a computer with the support of wired or wireless Internet functions. A standardized general-purpose OS (Operating System) can be used for these various functions.

Therefore, the display device described in the present invention can perform various user-friendly functions, for example, since various applications can be freely added or deleted on a general-purpose OS kernel. The above display device may be, more specifically, a network TV, HBBTV, smart TV, LED TV, OLED TV, etc., and may be applied to a smartphone in some cases.

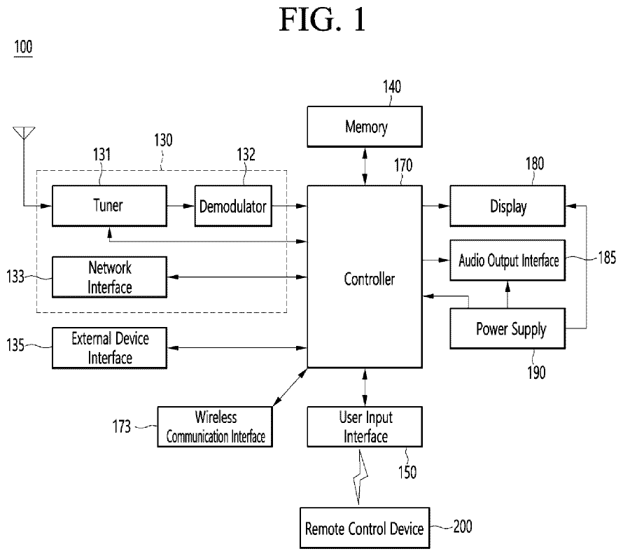

FIG. 1 is a block diagram illustrating the configuration of a display device 100 according to an embodiment of the present invention.

Referring to FIG. 1, the display device 100 may include a broadcast receiving unit 130, an external device interface 135, a memory 140, a user input interface 150, a controller 170, a wireless communication interface 173, a display 180, a speaker 185, and a power supply circuit 190.

The broadcast receiving unit 130 may include a tuner 131, a demodulator 132, and a network interface 133.

The tuner 131 may select a specific broadcast channel according to a channel selection command. The tuner 131 can receive a broadcast signal for a specific broadcast channel that has been selected.

The demodulator 132 can separate the received broadcast signal into a video signal, an audio signal, and a data signal related to a broadcast program, and can restore the separated video signal, audio signal, and data signal into a form that can be output.

The external device interface 135 can receive an application or an application list in an adjacent external device and transmit it to the controller 170 or the memory 140.

The external device interface 135 can provide a connection path between the display device 100 and the external device. The external device interface 135 can receive one or more of images and audio output from an external device connected to the display device 100 wirelessly or by wire and transmit it to the controller 170. The external device interface 135 can include a plurality of external input terminals. The plurality of external input terminals may include an RGB terminal, one or more HDMI (High Definition Multimedia Interface) terminals, and a component terminal.

A video signal of an external device input through an external device interface 135 may be output through a display 180. A voice signal of an external device input through an external device interface 135 may be output through a speaker 185.

An external device that can be connected to the external device interface 135 may be any one of a set-top box (STB), a Blu-ray player, a DVD player, a game console, a sound bar, a smartphone, a PC, a USB memory, and a home theater, but this is only an example.

The network interface 133 may provide an interface for connecting the display device 100 to a wired/wireless network including the Internet. The network interface 133 can transmit or receive data with other users or other electronic devices through the connected network or another network linked to the connected network.

In addition, some content data stored in the display device 100 can be transmitted to other users or other electronic devices pre-registered in the display device 100 to selected users or selected electronic devices.

The network interface 133 can access a predetermined web page through the connected network or another network linked to the connected network. That is, it can access a predetermined web page through the network and transmit or receive data with the corresponding server.

In addition, the network interface 133 can receive content or data provided by a content provider or a network operator. That is, the network interface 133 can receive content such as movies, advertisements, games, VOD, broadcast signals, etc. and information related thereto provided from a content provider or a network provider through the network.

In addition, the network interface 133 can receive update information and update files of firmware provided by the network operator, and can transmit data to the Internet or content provider or network operator.

The network interface 133 can select and receive a desired application from among applications open to the public through the network.

The memory 140 can store programs for each signal processing and control within the controller 170, and can store processed images, voices, or data signals.

In addition, the memory 140 can perform a function for temporary storage of images, voices, or data signals input from an external device interface 135 or a network interface 133, and can store information about a given image through a channel memory function.

The memory 140 can store an application or an application list input from an external device interface 135 or a network interface 133.

The display device 100 can play content files (video files, still image files, music files, document files, application files, etc.) stored in the memory 140 and provide them to the user.

The user input interface 150 can transmit a signal input by the user to the controller 170 or transmit a signal from the controller 170 to the user. For example, the user input interface 150 can receive and process control signals such as power on/off, channel selection, and screen setting from the remote control device 200 according to various communication methods such as Bluetooth, UWB (Ultra Wideband), ZigBee, RF (Radio Frequency) communication method, or infrared (IR) communication method, or process the control signals from the controller 170 to be transmitted to the remote control device 200.

In addition, the user input interface 150 can transmit a control signal input from a local key (not shown) such as a power key, a channel key, a volume key, a setting value, etc. to the controller 170.

An image signal processed by the controller 170 can be input to the display 180 and displayed as an image corresponding to the image signal. In addition, an image signal processed by the controller 170 can be input to an external output device through an external device interface 135.

An audio signal processed by the controller 170 can be output as audio to a speaker 185. In addition, an audio signal processed by the controller 170 can be input to an external output device through an external device interface 135.

In addition, the controller 170 can control the overall operation within the display device 100.

In addition, the controller 170 can control the display device 100 by a user command or an internal program input through the user input interface 150, and can allow the user to download a desired application or application list into the display device 100 by connecting to a network.

The controller 170 allows the user-selected channel information, etc. to be output through the display 180 or speaker 185 together with the processed image or audio signal.

In addition, the controller 170 allows the image signal or audio signal from an external device, such as a camera or camcorder, input through the external device interface 135 according to the external device image playback command received through the user input interface 150 to be output through the display 180 or speaker 185.

Meanwhile, the controller 170 can control the display 180 to display an image, and for example, can control a broadcast image input through the tuner 131, an external input image input through the external device interface 135, an image input through the network interface, or an image stored in the memory 140 to be displayed on the display 180. In this case, the image displayed on the display 180 can be a still image or a moving image, and can be a 2D image or a 3D image.

In addition, the controller 170 can control the content stored in the display device 100, or the received broadcast content, or the external input content input from the outside to be played, and the content can be in various forms such as a broadcast image, an external input image, an audio file, a still image, a connected web screen, a document file, etc.

The wireless communication interface 173 can perform communication with an external device through wired or wireless communication. The wireless communication interface 173 can perform short range communication with an external device. To this end, the wireless communication interface 173 can support short range communication using at least one of Bluetooth™, RFID (Radio Frequency Identification), Infrared Data Association (IrDA), UWB, ZigBee, NFC (Near Field Communication), Wi-Fi (Wireless-Fidelity), Wi-Fi Direct, and Wireless USB (Wireless Universal Serial Bus) technologies. The wireless communication interface 173 can support wireless communication between the display device 100 and a wireless communication system, between the display device 100 and another display device 100, or between the display device 100 and a network where the display device (100, or an external server) is located through a short range wireless communication network (Wireless Area Networks). The short-range wireless communication network may be a short-range wireless personal area network (Wireless Personal Area Networks).

Here, the other display device 100 may be a wearable device (e.g., a smart watch, smart glass, a head mounted display (HMD)) or a mobile terminal such as a smart phone that can exchange data with the display device 100 according to the present invention (or can be linked). The wireless communication interface 173 may detect (or recognize) a wearable device capable of communication around the display device 100.

Furthermore, if the detected wearable device is a device authenticated to communicate with the display device 100 according to the present invention, the controller 170 may transmit at least a part of the data processed in the display device 100 to the wearable device through the wireless communication interface 173. Therefore, the user of the wearable device can use the data processed in the display device 100 through the wearable device.

The display 180 can convert the image signal, data signal, OSD (On Screen Display) signal processed in the controller 170 or the image signal, data signal received from the external device interface 135 into R, G, B signals, respectively, to generate a driving signal.

Meanwhile, the display device 100 illustrated in FIG. 1 is only an embodiment of the present invention. Some of the illustrated components may be integrated, added, or omitted according to the specifications of the display device 100 actually implemented.

That is, two or more components may be combined into one component, or one component may be subdivided into two or more components, as needed. In addition, the functions performed by each block are for explaining an embodiment of the present invention, and the specific operations or devices thereof do not limit the scope of the rights of the present invention.

According to another embodiment of the present invention, the display device 100 may receive and play back images through a network interface 133 or an external device interface 135 without having a tuner 131 and a demodulator 132 as shown in FIG. 1.

For example, the display device 100 may be implemented separately as an image processing device such as a set-top box (STB) for receiving contents according to broadcast signals or various network services, and a content playback device for playing back contents input from the image processing device.

In this case, the operation method of the display device according to the embodiment of the present invention described below may be performed by any one of the image processing device such as the separated set-top box (STB) or the content playback device having a display 180 and an audio output unit 185 as well as the display device 100 described with reference to FIG. 1.

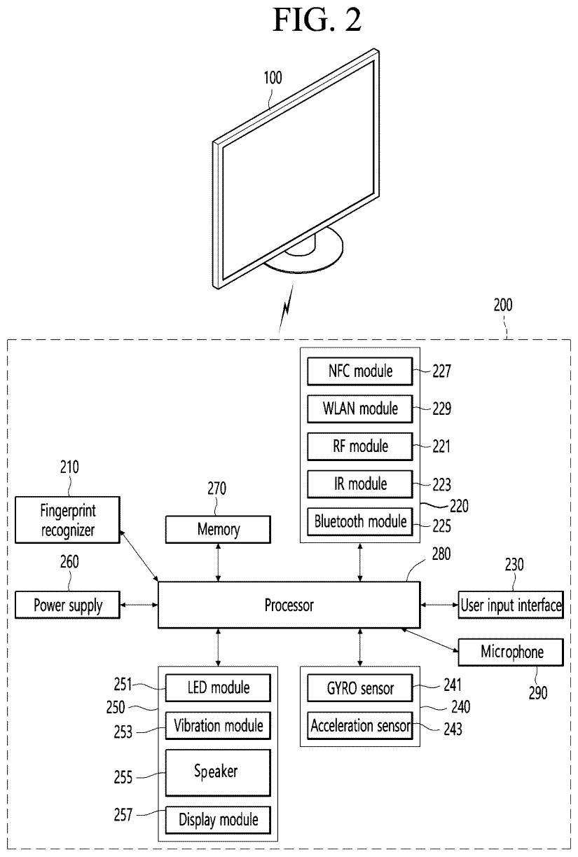

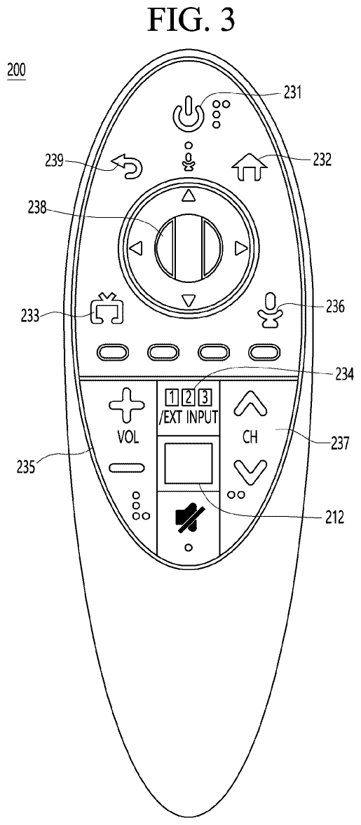

Next, with reference to FIGS. 2 and 3, a remote control device according to an embodiment of the present invention will be described.

FIG. 2 is a block diagram of a remote control device according to an embodiment of the present invention, and FIG. 3 illustrates an example of an actual configuration of a remote control device 200 according to an embodiment of the present invention.

First, with reference to FIG. 2, the remote control device 200 may include a fingerprint recognition device 210, a wireless communication circuit 220, a user input interface 230, a sensor 240, an output interface 250, a power supply circuit 260, a memory 270, a controller 280, and a microphone 290.

With reference to FIG. 2, the wireless communication circuit 220 transmits and receives signals with any one of the display devices 100 according to the embodiments of the present invention described above.

The remote control device 200 may be equipped with an RF circuit 221 capable of transmitting/receiving signals with the display device 100 according to RF communication standards, and an IR circuit 223 capable of transmitting/receiving signals with the display device 100 according to IR communication standards. In addition, the remote control device 200 may be equipped with a Bluetooth circuit 225 capable of transmitting/receiving signals with the display device 100 according to Bluetooth communication standards. In addition, the remote control device 200 may be equipped with an NFC circuit 227 capable of transmitting/receiving signals with the display device 100 according to NFC (Near Field Communication) communication standards, and a WLAN circuit 229 capable of transmitting/receiving signals with the display device 100 according to WLAN (Wireless LAN) communication standards.

In addition, the remote control device 200 transmits a signal containing information about the movement of the remote control device 200 to the display device 100 through the wireless communication circuit 220.

Meanwhile, the remote control device 200 can receive a signal transmitted by the display device 100 through the RF circuit 221, and, if necessary, can transmit commands for power on/off, channel change, volume change, etc. to the display device 100 through the IR circuit 223.

The user input interface 230 can be composed of a key pad, a button, a touch pad, or a touch screen. The user can input a command related to the display device 100 to the remote control device 200 by operating the user input interface 230. If the user input interface 230 is equipped with a hard key button, the user can input a command related to the display device 100 to the remote control device 200 through a push operation of the hard key button. This will be explained with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, a confirmation button 238, and a back button 239.

The fingerprint recognition button 212 may be a button for recognizing a user's fingerprint. In one embodiment, the fingerprint recognition button 212 may be capable of a push operation, and may receive a push operation and a fingerprint recognition operation.

The power button 231 may be a button for turning the power of the display device 100 on/off.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the size of the volume output by the display device 100.

The voice recognition button 236 may be a button for receiving a user's voice and recognizing the received voice.

The channel change button 237 may be a button for receiving a broadcast signal of a specific broadcast channel.

The confirmation button 238 may be a button for selecting a specific function, and the back button 239 may be a button for returning to the previous screen.

FIG. 2 will be described again.

If the user input interface 230 has a touch screen, the user can input a command related to the display device 100 to the remote control device 200 by touching the soft key of the touch screen. In addition, the user input interface 230 can have various types of input means that the user can operate, such as a scroll key or a jog key, and this embodiment does not limit the scope of the rights of the present disclosure.

The sensor 240 can have a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 may further be equipped with a distance measuring sensor, so as to sense the distance to the display 180 of the display device 100.

The output interface 250 can output a video or audio signal corresponding to the operation of the user input interface 230 or the signal transmitted from the display device 100.

The user can recognize whether the output interface 250 is being operated by the user input interface 230 or whether the display device 100 is being controlled.

For example, the output interface 250 can be equipped with an LED 251 that lights up when the user input interface 230 is operated or a signal is transmitted and received with the display device 100 through the wireless communication unit 225, a vibrator 253 that generates vibration, a speaker 255 that outputs sound, or a display 257 that outputs an image.

In addition, the power supply circuit 260 supplies power to the remote control device 200, and power waste can be reduced by stopping the power supply when the remote control device 200 does not move for a predetermined period of time.

The power supply circuit 260 can resume the power supply when a predetermined key provided in the remote control device 200 is operated.

The memory 270 can store various types of programs, application data, etc. required for the control or operation of the remote control device 200.

When the remote control device 200 wirelessly transmits and receives signals through the display device 100 and the RF circuit 221, the remote control device 200 and the display device 100 transmit and receive signals through a predetermined frequency band.

The controller 280 of the remote control device can store and refer to information about the frequency band that can wirelessly transmit and receive signals with the display device 100 paired with the remote control device 200 in the memory 270.

The controller 280 controls all matters related to the control of the remote control device 200. The controller 280 can transmit a signal corresponding to a predetermined key operation of the user input interface 230 or a signal corresponding to the movement of the remote control device 200 sensed by the sensor 240 to the display device 100 through the wireless communication unit 225.

In addition, the microphone 290 of the remote control device 200 can acquire voice.

A plurality of microphones 290 can be provided.

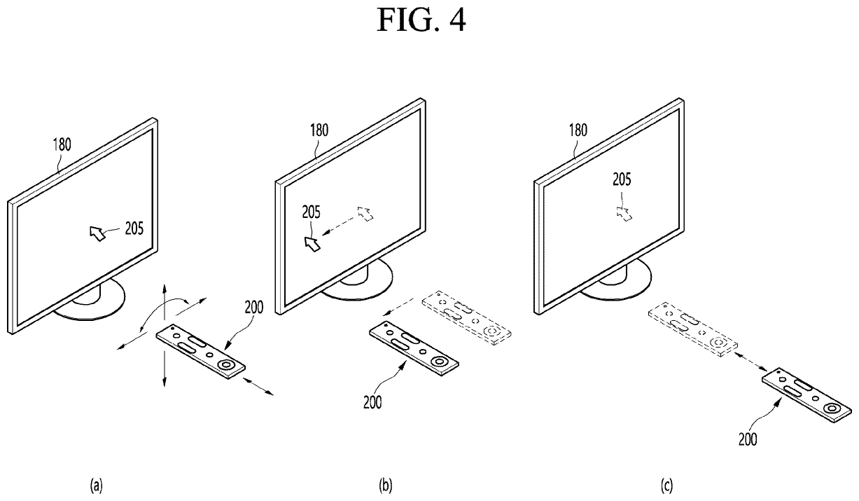

Next, FIG. 4 is described.

FIG. 4 illustrates an example of utilizing a remote control device 200 according to an embodiment of the present invention.

(a) of FIG. 4 illustrates that a pointer 205 corresponding to a remote control device 200 is displayed on a display 180.

A user can move or rotate the remote control device 200 up and down, left and right. The pointer 205 displayed on the display 180 of the display device 100 corresponds to the movement of the remote control device 200. This remote control device 200 can be named a ‘space remote control’ because the pointer 205 moves and is displayed according to the movement in 3D space, as shown in the drawing.

(b) of FIG. 4 exemplifies that when a user moves the remote control device 200 to the left, the pointer 205 displayed on the display 180 of the display device 100 also moves to the left in response.

Information about the movement of the remote control device 200 detected through the sensor of the remote control device 200 is transmitted to the display device 100. The display device 100 can calculate the coordinates of the pointer 205 from the information about the movement of the remote control device 200. The display device 100 can display the pointer 205 in response to the calculated coordinates.

(c) of FIG. 4 exemplifies a case where a user moves the remote control device 200 away from the display 180 while pressing a specific button in the remote control device 200. By this, the selection area in the display 180 corresponding to the pointer 205 can be zoomed in and displayed in an enlarged manner.

Conversely, when the user moves the remote control device 200 closer to the display 180, the selection area in the display 180 corresponding to the pointer 205 can be zoomed out and displayed in a reduced manner.

Meanwhile, when the remote control device 200 moves away from the display 180, the selection area can be zoomed out, and when the remote control device 200 moves closer to the display 180, the selection area can be zoomed in.

In addition, when a specific button in the remote control device 200 is pressed, the recognition of up/down and left/right movement can be excluded. That is, when the remote control device 200 moves away from or toward the display 180, the up, down, left, and right movements are not recognized, and only the forward and backward movements are recognized. When a specific button in the remote control device 200 is not pressed, only the pointer 205 moves according to the up, down, left, and right movements of the remote control device 200.

Meanwhile, the moving speed or moving direction of the pointer 205 may correspond to the moving speed or moving direction of the remote control device 200.

Meanwhile, the pointer in this specification means an object displayed on the display 180 in response to the operation of the remote control device 200. Therefore, in addition to the arrow shape illustrated in the drawing, the pointer 205 may be a concept including a point, a cursor, a prompt, a thick outline, etc. And the pointer 205 may be displayed corresponding to one point of the horizontal and vertical axes on the display 180, and may also be displayed corresponding to multiple points such as lines and surfaces.

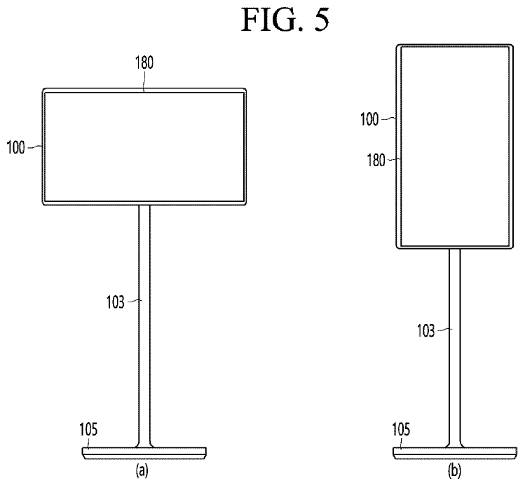

(a) of FIG. 5 and (b) of FIG. 5 are drawings for explaining the horizontal mode and vertical mode of a stand-type display device according to an embodiment of the present disclosure.

Referring to (a) of FIG. 5 and (b) of FIG. 5, a stand-type display device 100 is illustrated.

A shaft 103 and a stand base 105 may be connected to the display device 100.

The shaft 103 may connect the display device 100 and the stand base 105. The shaft 103 may be extended vertically.

The lower end of the shaft 103 may be connected to the edge of the stand base 105.

The lower end of the shaft 103 may be rotatably connected to the periphery of the stand base 105.

The display device 100 and the shaft 103 may be rotated around a vertical axis relative to the stand base 105.

The upper end of the shaft 103 may be connected to the rear of the display device 100.

The stand base 105 may serve to support the display device 100.

The display device 100 may be configured to include the shaft 103 and the stand base 105.

The display device 100 can rotate around the point where the upper part of the shaft 103 and the rear part of the display 180 meet.

(a) of FIG. 5 illustrates that the display 180 operates in a horizontal mode in which the horizontal length is greater than the vertical length, and (b) of FIG. 5 illustrates that the display 180 operates in a horizontal mode in which the vertical length is greater than the horizontal length.

The user can hold and move the stand-type display device. That is, unlike fixed devices, the stand-type display device 100 has improved mobility, so the user is not restricted by the placement location.

Hereinafter, when multiple external devices are directly/indirectly connected to the display device 100, a method for integrating and controlling the external devices through a single input means will be described with reference to the attached drawings.

Hereinafter, the input means includes the remote control device 200 described in FIGS. 2 to 4 for convenience of explanation, and in particular, a remote control (e.g., a space remote control, a magic remote control, etc.) is described as an example, but is not limited thereto. For example, in addition to the remote control, a mobile terminal with a related application installed may also be an input means.

Meanwhile, a direct connection refers to a case where an external device is directly connected through an input port of a display device 100, and an indirect connection refers to a case where an external device is not connected to the display device 100, but is connected to the display device 100 through another external device.

Meanwhile, in the present disclosure, the direct/indirect connection is described as an example of a connection through HDMI (High Definition Multimedia Interface), but is not limited thereto.

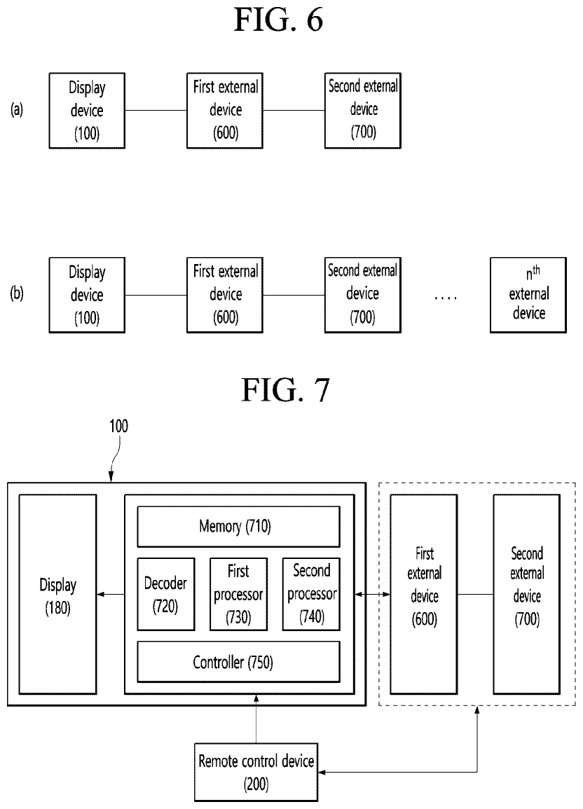

FIG. 6 is a drawing illustrating a direct/indirect connection method related to the present disclosure.

In (a) and (b) of FIG. 6, the display device 100 and a plurality of external devices are shown to be connected serially. This serial connection method is also commonly referred to as a cascade connection method.

In (a) of FIG. 6, the display device 100, the first external device 600, and the second external device 700 are shown to be connected serially, for a total of three devices.

At this time, the display device 100 and the first external device 600 can be described as being directly connected, and the display device 100 and the second external device 700 can be described as being indirectly connected, for example, since they are connected through the first external device 600. However, this is not limited to the names such as direct connection, indirect connection, etc.

Meanwhile, the display device 100 can receive and process data from an indirectly connected second external device 700, and at this time, the first external device 600 can transmit and receive signals such as data in the middle.

In addition, there may be no special restrictions on data formats such as audio, video, and images for signals such as data.

Meanwhile, (b) of FIG. 6 is similar to (a) of FIG. 6, but illustrates a case where the number of external devices is n (where n is a positive integer).

However, for convenience of explanation, the following description will be made using two external devices, namely, a first external device directly connected to the display device 100 and a second external device indirectly connected to the display device 100 through the first external device.

In addition, for convenience of explanation, the first external device will be described using a sound bar as an example and the second external device will be described using a set-top box (STB) as an example, but the present invention is not limited thereto. For example, the second external device may include various devices such as a game console in addition to a set-top box (STB).

FIG. 7 is a block diagram of a display device 100 for controlling multiple external input devices connected through a single remote control device 200 according to an embodiment of the present disclosure.

The display device 100 may be configured to include a display 180 and a processor module.

The display device 100, particularly the processor module, may communicate with the remote control device 200 and exchange signals containing codes as described above in FIGS. 2 to 4.

In addition, the processor module may exchange signals containing data with multiple external devices 600, 700 directly/indirectly connected to the display device 100.

The display device 100 may be configured to include a remote control device 200 and a processor module.

In the following description of the display device 100, any content overlapping with that described above in FIGS. 1 to 5 will be referred to and any overlapping description will be omitted. In addition, the description of the configuration and function of the remote control device 200 (e.g., remote control) below refers to at least one of the descriptions of FIGS. 2 to 4 described above, and no duplicate description is made herein.

Referring to FIG. 7, the processor module may be configured to include a memory 710, a decoder 720, a first processor 730, a second processor 740, and a controller 750.

The processor module may receive a user's input through the remote control device 200. The processor module may communicate with external devices 600, 700 to configure a screen according to the user's input and output it through the display 180.

The memory 710 may store various data, for example, data received or processed by the processor module. The memory 710 may have the same configuration as the memory 140 illustrated in FIG. 1 or a separate configuration.

The controller 750 can control or perform the overall operation of the processor module or display device 100, including data communication, user interface configuration and provision, control operations, etc. between the remote control device 200 and/or external devices 600, 700. The controller 750 can have the same configuration as the controller 170 of FIG. 1 or a separate configuration, for example.

The decoder 720 can decode input image data.

The first processor 730 can process the image data decoded by the decoder 720 to be output. In this sense, the first processor 730 can be named a video processor.

The second processor 740 can perform processing for the graphic area. In this sense, the second processor 740 can be named a graphic processor.

As shown in FIG. 7, when a set-top box (STB) (second external device) 700 is connected to a sound bar (first external device) 600 directly connected to a display device 100, the screen of the set-top box 700 can be output from the device to which the sound bar is connected, i.e., the display device 100.

However, the display device 100 cannot identify which external device is connected to the sound bar 600, other than the sound bar 600 directly connected to the display device 100.

Therefore, the display device 100 can receive HDMI-CEC information for the sound bar 600 and automatically set it up for integrated control via the remote control device 200 based on the information, but the external device 700 connected to the sound bar 600 cannot be automatically set up or integrated control via the remote control device 200.

Accordingly, in this disclosure, an external device connected to a sound bar 600, i.e., a set-top box 700, can be integratedly controlled through a single input means, i.e., a remote control device 200, thereby improving the user convenience.

To this end, the display device 100 according to this disclosure receives HDMI-CEC information of a set-top box 700 connected to a sound bar 600 through the sound bar 600, and, based on the received HDMI-CEC information, controls not only the sound bar 600 but also the set-top box 700 with only a single remote control device 200.

The operation of the specific display device 100 will be described with reference to the drawings described below, as follows.

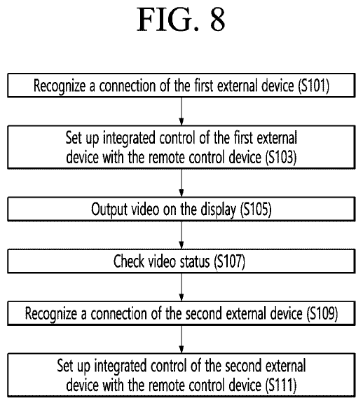

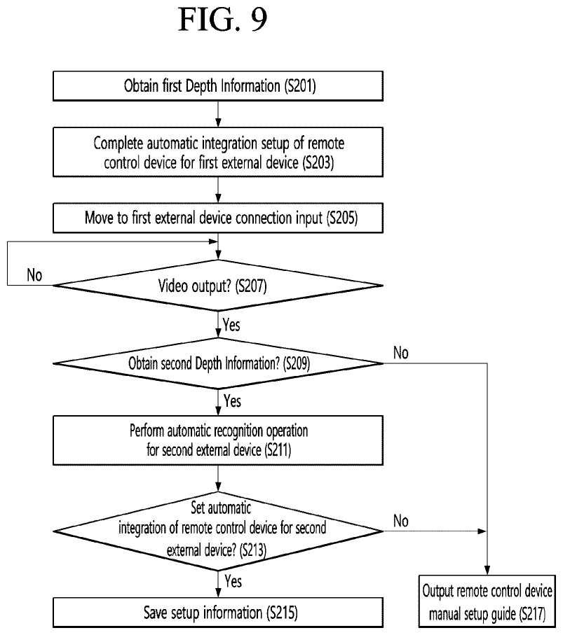

FIGS. 8 and 9 are flowcharts illustrating an operation method of the display device 100 according to an embodiment of the present disclosure.

First, referring to FIG. 8, in step S101, the controller 750 of the display device can recognize the connection of the sound bar 600.

In step S103, the controller 750 can set the sound bar 600 to be integratedly controlled through the remote control device 200.

In step S105, the controller 750 can output a video through the display.

In step S107, the controller 750 can check the status of the video.

In step S109, the controller 750 can recognize the connection of the set-top box 700 based on the video status check result.

In step S111, the controller 750 can set the set-top box 700 to be integratedly controlled through the remote control device 200.

In relation to the above step S105, the image can be automatically output when the set-top box 700 is connected to the sound bar 600 via HDMI as described above. From this perspective, although the output of the image is described in step S105, it can be performed together with step S101 or before or simultaneously with step S103. At this time, both the sound bar 600 and the set-top box 700 must be in a power-on state.

According to another embodiment, even if the set-top box 700 is connected to the sound bar 600 via HDMI, the display device 100 can stand by without automatically outputting the image. At this time, the standby can continue until steps S109 to S111 described below are performed, for example.

In steps S107 to S109, the video status check may indicate, for example, whether additional HDMI-CEC information (about the set-top box 700) is received from the display device 100 through the sound bar 600 in addition to the HDMI-CEC information about the sound bar.

The display device 100 may recognize that an external device is additionally connected to the sound bar 600 as described in step S109, based on the additional HDMI-CEC information.

The integrated control setting method through the remote control device 200 of step S111 will be described in more detail with reference to FIG. 9 described below.

In describing the operation of the display device 100 according to FIG. 9, the following may be defined or referenced.

When an HDMI device 700 is connected to a sound bar 600, the sound bar 600 can transmit HDMI-CEC information of the sound bar 600 and the HDMI device 700 to the connected input, i.e., the display device 100. At this time, the HDMI-CEC information for the two external devices can be transmitted sequentially or simultaneously.

Referring to FIGS. 6 and 7, the first external device 600 can be defined as the first depth, and the second external device 700 can be defined as the second depth, and in the same manner, which device is connected serially. For example, as shown in (b) of FIG. 6, when n external devices are connected serially between them and the display device 100, the nth depth can be defined.

The display device 100 can perform the following operations when the sound bar 600 is automatically recognized and an image is output to the corresponding HDMI input (for example, a valid signal is detected when checking the video status).

When the display device 100 receives HDMI-CEC information of the second depth through the HDMI input, the display device 100 can perform an automatic recognition operation of the set-top box 700 based on the received HDMI-CEC information.

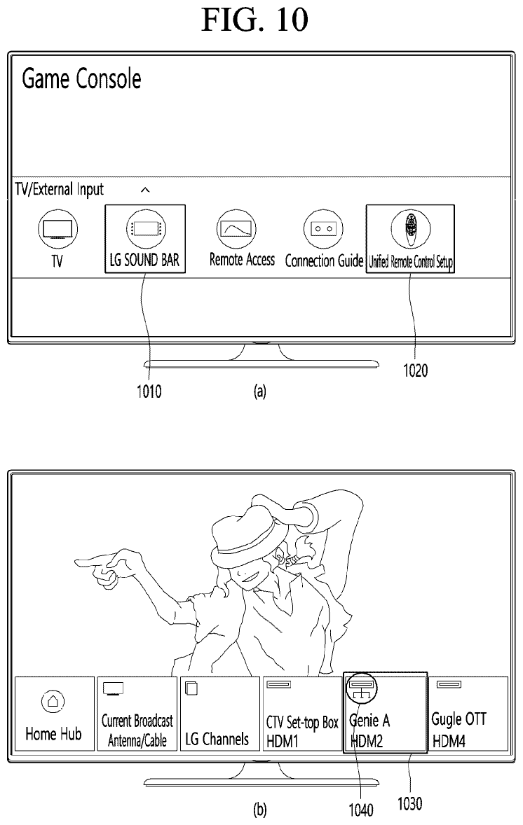

When the automatic recognition is completed, the display device 100 can control both the sound bar 600 and the HDMI device 700 with the remote control device 200, and output the HDMI device information to the HDMI input as shown in (b) of FIG. 10.

FIG. 10 is a drawing illustrating displaying a list of external devices connected to a display device.

In (a) of FIG. 10, the display device 100 outputs an image of a second external device 700 (e.g., a game console), but only an icon for a first external device 1010 may be provided in the external input list. In this case, by selecting the integrated remote control setting icon 1020, an integrated control setting operation with a remote control device 200 for the second external device 700 may be performed. Meanwhile, when accessing the icon for the first external device 1010 in (a) of FIG. 10, an icon for the second external device 700 may also be provided.

Meanwhile, in (b) of FIG. 10, the display device 100 outputs the image of the HDMI2 input, and a box 1030 for the second external device may be provided on the external input list. However, in this case, the second external device 700 may be provided so that it can be identified through an icon 640 that it is not directly connected to the display device 100, but is serially connected to the first external device 600, i.e., indirectly connected.

If the display device 100 fails to automatically recognize the HDMI device 700 despite receiving HDMI-CEC information, the display device 100 may output a manual setup guide so that the user can manually control the HDMI device 700 using the remote control device 200. The provision of the manual setup guide will be described later.

On the other hand, if the display device 100 does not receive the second depth HDMI-CEC information through the HDMI input, it can likewise provide a manual setup guide for the user. In this case, since the display device 100 already outputs the video of the HDMI device 700, even if it is difficult to recognize the HDMI device 700 through the HDMI-CEC, the display device 100 can at least recognize the existence of the HDMI device 700, so it can provide a manual setup guide.

Referring to FIG. 9, in step S201, the controller 750 can obtain the first depth HDMI-CEC information.

In step S203, the controller 750 can complete the automatic integrated control setting for the sound bar 600 through the remote control device 200.

At step S205, the controller 750 can move to the sound bar 600 connection input.

At step S207, the controller 750 can determine whether an image is output through the display 180.

At step S209, the controller 750 can determine whether second depth information is acquired if the image is output through the display 180 as a result of the determination at step S207.

At step S211, the controller 750 can perform an automatic recognition operation for the set-top box 700 if the second depth information is acquired as a result of the determination at step S209.

At step S213, the controller 750 can determine whether the automatic integration setting operation with the remote control device 200 for the set-top box 700 is being performed and completed.

At step S215, the controller 750 can store the corresponding setting information if the automatic integration setting operation with the remote control device 200 for the set-top box 700 is performed and completed as a result of the determination at step S213.

On the other hand, in step S217, if the second depth information is not acquired in step S209 or the automatic integration setting operation with the remote control device 200 for the set-top box 700 is not performed in step S213, the controller 750 recognizes the existence of the second external device 700 through the image output through step S207, and thus generates a manual integration setting guide with the remote control device 200 and outputs it through the display 180.

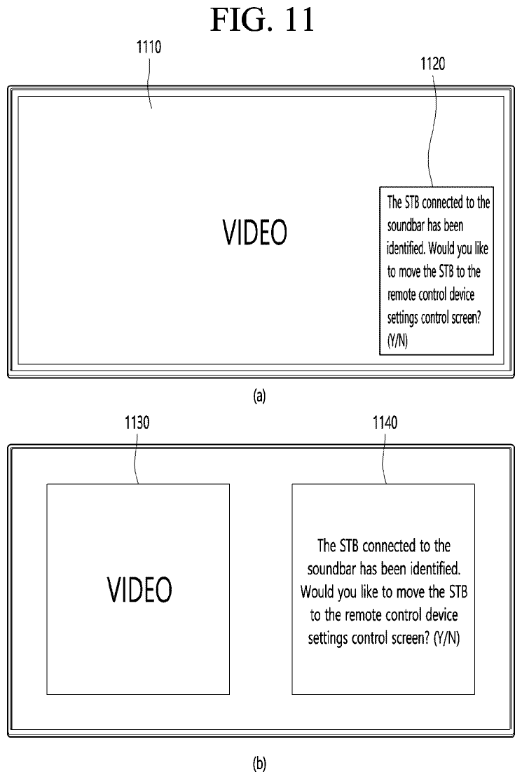

FIGS. 11 to 13 are drawings illustrating a setting method for integrated control through a remote control device in a display device according to an embodiment of the present disclosure.

Referring to FIGS. 11 to 13, an embodiment of the operation of the display device 100 related to the aforementioned manual integration setting guide will be described.

First, FIG. 11 describes a method of providing a manual integration setting guide.

In (a) of FIG. 11, the display device 100 may provide a manual integration setting guide in the form of a pop-up window 1120 or an OSD message while providing a video through the screen 1110.

In (b) of FIG. 11, if the display device 100 must output a manual integration setting guide and supports a multi-view mode, the display device 100 may switch the screen mode to the multi-view mode, so that the video being output in the first view 1130 may continue to be provided, and the manual integration setting guide may be output in the second view 1140. In this case, if the display device 100 determines that the manual integration setting operation through the manual integration setting guide is completed or that the manual integration setting operation is no longer performed, the display device 100 may switch back to the original screen mode.

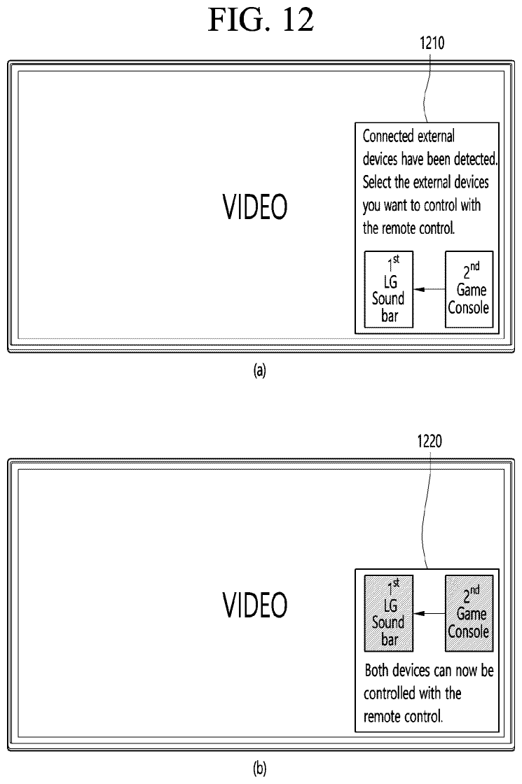

Next, in the case of FIG. 12, the display device 100 may provide information on the target of the manual integration setting and the setting status when providing the manual integration setting guide.

Referring to (a) of FIG. 12, the display device 100 may output the manual integration setting guide 1210 on one area of the display 180, and may provide the list of external devices that are the target of the manual integration setting and the relationship between them (e.g., depth information) so that they can be identified.

(b) of FIG. 12 is, for example, a manual integration setting guide 1220 when the manual integration setting operation is completed or stopped through (a) of FIG. 12, and in this case, the list of external devices for which the manual integration setting is completed is provided so that it can be identified that it is completed, and a related message may also be provided.

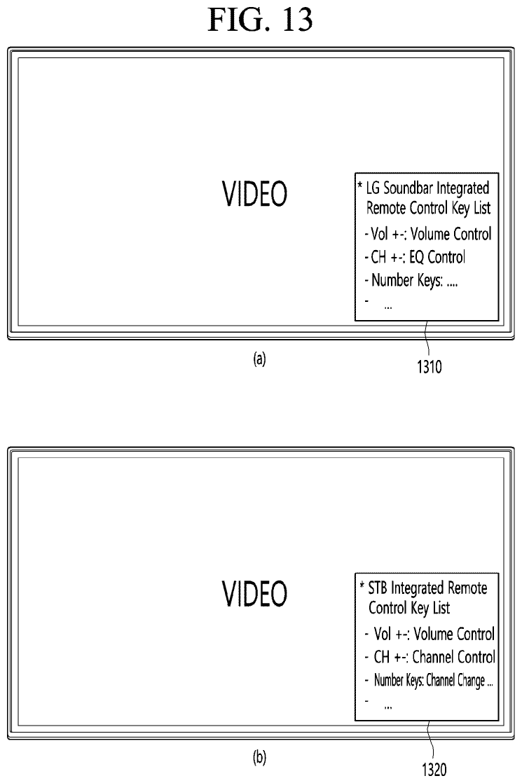

Meanwhile, in FIG. 13, when integrated control of multiple external devices is enabled through one input means, i.e., a remote control device 200, according to the aforementioned manual integrated setting operation (or automatic integrated setting operation), key mapping information or special information of the remote control device 200 may be provided for each external device.

In (a) of FIG. 13, for example, a guide guide 1310 including a list of control keys of a remote control device 200 for an LG sound bar may be provided, and in (b) of FIG. 13, a guide guide 1320 including a list of control keys of a remote control device 200 for a set-top box may be provided.

Although FIGS. 11 to 13 have described messages implemented in text form as an example, the present disclosure is not limited thereto. For example, messages may be provided in various forms such as audio, video, and images.

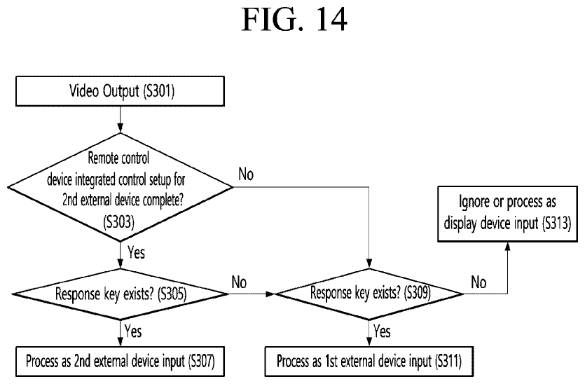

FIG. 14 is a flow chart illustrating an operation method of a display device according to another embodiment of the present disclosure.

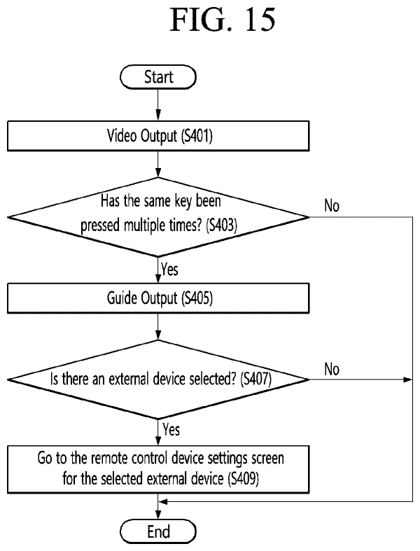

FIG. 15 is a flow chart illustrating an operation method of a display device according to another embodiment of the present disclosure.

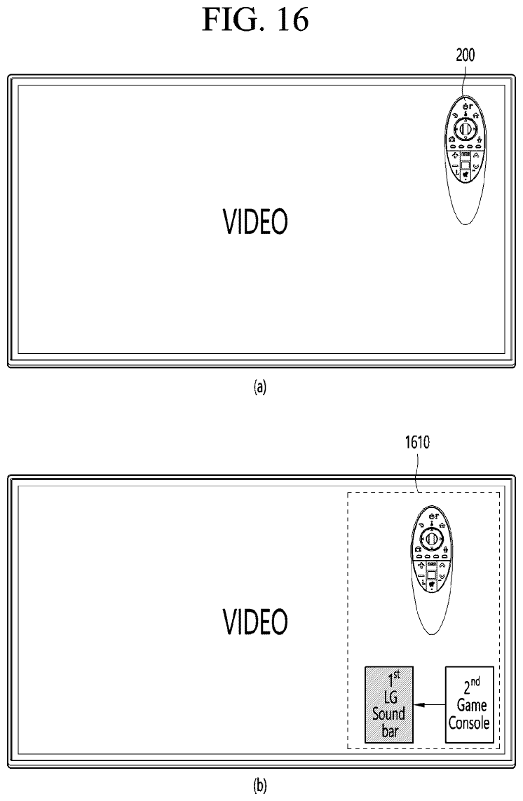

FIG. 16 is a drawing illustrating a setting method for integrated control through a remote control device in a display device according to another embodiment of the present disclosure.

FIG. 14 may be about how to process an input through a remote control device 200 after video output as an input for a device. According to another embodiment, in the case where a video is output through the screen of the display device 100, assuming that the integrated control setting for the second external device 700 is completed through the remote control device 200, the input of the remote control device 200 is considered as an input for the second external device 700 first, but it may also be a method of determining whether or not an input of another device is made based on the presence or absence of a corresponding key.

Referring to FIG. 14, in step S301, the controller 750 can output the video of the second external device 700 through the display 180.

In step S303, the controller 750 can determine whether the integrated control setting for the second external device 700 through the remote control device 200 is completed when the video is output in step S301.

In step S305, the controller 750 can determine whether a key corresponding to the key input through the remote control device 200 exists. Depending on the embodiment, step S305 may be performed regardless of whether the integrated control setting is completed as a result of the determination in step S303.

In step S307, if the corresponding key exists as a result of the determination in step S305, the controller 750 can process the key input entered through the remote control device 200 as a key input for controlling the second external device 700.

In step S309, if the integrated control setting is not completed in step S303 or the corresponding key does not exist as a result of the determination in step S305, the controller 750 can determine whether a corresponding key exists in order to determine whether the key input is for controlling the first external device 600.

In step S311, if the controller 750 determines in step S309 that there is a corresponding key, the remote control device 200 can process the integrated key input as a key input for controlling the first external device 600 rather than the second external device 700.

In step S313, if the controller 750 determines in step S309 that there is no corresponding key, the key input through the remote control device 200 can be processed or discarded as input of the display device 100 rather than the first external device 600 and the second external device 700.

Next, FIG. 15 discloses a processing method when multiple identical key inputs through the remote control device 200 are received while the video is being output through the display device 100.

Referring to FIG. 15, in step S401, the controller 750 can output the video of the second external device 700 through the display 180.

In step S403, the controller 750 can determine whether the same key input has been repeatedly pressed a predetermined number of times or more within a predetermined threshold time through the remote control device 200.

In step S405, the controller 750 can provide a guidance guide to accurately identify what additional operation is required or what content of control is desired for the user to control the display device 100 through the remote control device 200 in this case. At this time, the guidance guide can be, for example, a user interface screen such as (a) or (b) of FIG. 16.

In step S407, the controller 750 can receive a user's selection signal according to the guidance guide provided in step S405, and can determine whether there is a selected external device.

In step S409, the controller 750 can move to the integrated control setting screen via the remote control device 200 for the selected external device.

As described above, in the case of FIG. 15, when the user wants to control the display device 100 or the external device(s) while not knowing which external device(s) directly/indirectly connected to the display device 100 has completed the integrated control setting with the remote control device 200, this can be a solution.

Referring to FIG. 16, as one of the solutions of FIG. 15, the guidance guide and its processing method are explained as follows.

FIG. 16 is explained assuming the aforementioned FIG. 15 for convenience of explanation, but is not limited thereto.

Referring to (a) of FIG. 16, the display device 100 may provide an icon for the remote control device 200 in an area of the screen on which the video is being output. This may be provided to enable the user to identify that integrated settings related to the remote control device 200 are required or that there is a related issue. Meanwhile, in (a) of FIG. 16, only a simple icon is provided, but additional related explanations may be provided in the form of text or audio.

If no additional signal is received in (a) of FIG. 16 or if the user inputs the same key again or selects the remote control device 200 icon, the display device 100 may provide a guidance guide 1610 such as (b) of FIG. 16.

Referring to (b) of FIG. 16, the display device 100 can display boxes for external devices directly/indirectly connected together with the remote control device 200 icon, and the boxes representing each external device can be provided so that it can be intuitively identified whether they are linked with the remote control device 200, that is, whether the integrated control setting is complete. For example, in the case of (b) of FIG. 16, it can be intuitively identified that the LG sound bar is connected as the first depth and the game console is serially connected as the second depth, and the LG sound bar is linked with the remote control device 200 and the integrated control setting is complete, but the game console is not yet linked with the remote control device 200.

The controller 750 may control to perform an automatic integrated control setting operation with the remote control device 200 or guide manual integrated control setting when a box corresponding to the second depth game console is selected on the guide guide 610 provided in (b) of FIG. 16.

Meanwhile, FIG. 16 is not necessarily applied only to external devices connected serially according to the present disclosure, and may be used for a linkage operation with the remote control device 200 for various external devices that are directly connected, including multiple external devices, and are connected wired/wirelessly with the display device 100.

Referring to the above, the display system according to the present disclosure may include the display device including an input means for controlling the display device, multiple external devices connected to each other in a cascade manner via HDMI, and a controller for setting the multiple external devices to be integratedly controlled by the input means and controlling the multiple external devices. At this time, the controller may set the first external device to be controlled through the input means when the connection of the first external device is recognized, and control the video to be output through the display, but may set the second external device to be controlled through the input means when the status of the video is checked and the connection of the second external device is recognized.

Even if not specifically mentioned, the order of at least some of the operations disclosed in the present disclosure may be performed simultaneously or in a different order from the described order, or some may be omitted/added.

According to at least one of the various embodiments of the present disclosure described above, a plurality of external devices directly/indirectly connected to the display device 100 may be integratedly controlled through one input means, and at this time, an automatic setting service may be provided so that the plurality of external devices may be integratedly controlled through the one input means, and an external device(s) that are not controlled through the input means among the external devices indirectly connected to the display device 100 may be identified, and a guide for manual connection setting may be provided, thereby improving the user satisfaction with the display device 100.

According to one embodiment of the present invention, the above-described method can be implemented as a code that can be read by a processor on a medium in which a program is recorded. Examples of the medium that can be read by a processor include ROM, RAM, CD-ROM, magnetic tape, floppy disk, optical data storage device, etc.

The display device described above is not limited to the configuration and method of the embodiments described above, and the embodiments can be configured by selectively combining all or part of each embodiment so that various modifications can be made.

### INDUSTRIAL APPLICABILITY

According to the display device according to the present disclosure, since integrated control is possible through a single input means for a plurality of external devices directly/indirectly connected to the display device, the usability can be greatly improved, and therefore, there is industrial applicability.

What is claimed is:

1. A method of operating a display device, comprising:
when a connection of a first external device is recognized, setting the first external device to be controlled via an input means;
outputting a video through a display;
recognizing a connection of a second external device by checking a status of the video; and
setting the second external device to be controlled via the input means.

2. The method of claim 1, wherein the second external device is connected only to the first external device and not to the display device.

3. The method of claim 2, wherein the display device and the first external device, and the first external device and the second external device are respectively connected via an HDMI.

4. The method of claim 3, wherein checking the status of the video to recognize the connection of the second external device comprises:
when additional HDMI-CEC information as a result of the video status check is received, performing an operation for automatically recognizing the second external device based on the additional HDMI-CEC information.

5. The method of claim 4, wherein when the automatic recognition of the second external device fails, a manual setup guide for controlling the second external device via the input means is output.

6. The method of claim 3, wherein when no additional HDMI-CEC information is received as a result of the video status check, a manual setup guide for controlling the second external device via the input means is output.

7. The method of claim 1, wherein the first external device is a sound bar, and the second external device includes at least one of a set-top box and a game console.

8. A display device comprising:
a display; and
a controller configured to control the display, wherein the controller is configured to:
when a connection of a first external device is recognized, set the first external device to be controlled via an input means,
control the display to output a video,
check a status of the video to recognize a connection of a second external device, and
set the second external device to be controlled via the input means.

9. The display device of claim 8, wherein the second external device is connected only to the first external device and not to the display device.

10. The display device of claim 9, wherein the display device and the first external device, and the first external device and the second external device are respectively connected via HDMI.

11. The display device of claim 10, wherein the controller is configured to:
when additional HDMI-CEC information as a result of the video status check is received, perform an operation for automatically recognizing the second external device based on the additional HDMI-CEC information.

12. The display device of claim 11, wherein the controller is further configured to: when the automatic recognition of the second external device fails, control the output of a manual setup guide for controlling the second external device via the input means.

13. The display device of claim 10, wherein the controller is configured to:
when no additional HDMI-CEC information is received as a result of the video status check, control the output of a manual setup guide for controlling the second external device via the input means.

14. The display device of claim 8, wherein the first external device is a sound bar, and the second external device includes at least one of a set-top box and a game console.
